(19) United States
(12) Patent Application Publication
(10) Pub. No.: US 2017/0253341 A1
(43) Pub. Date: Sep. 7, 2017

(54) ADJUSTMENT FEATURES FOR ENGINE COWL DOOR

(71) Applicant: SIKORSKY AIRCRAFT CORPORATION, Stratford, CT (US)

(72) Inventors: Robert F. Shortt, JR., Milford, CT (US); Charles F. Lang, Monroe, CT (US); Dale C. Humphries, Berlin, CT (US)

(21) Appl. No.: 15/501,142

(22) PCT Filed: Aug. 25, 2015
(86) PCT No.: PCT/US15/46674

§ 371 Date: Feb. 1, 2017

Related U.S. Application Data
(60) Provisional application No. 62/041,189, filed on Aug. 25, 2014.

(51) Int. Cl. B64D 29/06; B64D 27/16; B64C 27/06; B64F 5/40

(52) U.S. Cl. CPC B64D 29/06; B64F 5/40; B64D 27/16; B64C 27/06

(57) ABSTRACT

An adjustment tool is provided including a block having a plurality of sides including a first side and a second side. A hole is formed in the block such that a first distance between the center of the hole and the first side is different from a second distance between the center of the hole and the second side. The first distance corresponds to a first standard size component and the second distance corresponds to a second standard size component.

### BACKGROUND OF THE INVENTION

Exemplary embodiments of the invention relate to a rotary wing aircraft, and more particularly, to a tool and method for adjusting the position seat restraint intended for use with side facing seats of a rotary wing aircraft.

Gas turbine engines used on both fixed and rotary wing aircrafts commonly require maintenance and repair work. Engine cowlings are commonly constructed as half cylinders hingedly attached to the engine or an adjacent surface to allow the cowl to pivot away from and provide access to the engine core. Conventional connection assemblies used to couple the cowl door to the engine or airframe do not allow for any adjustment. In instances where fit problems occur, such as when an engine is being reinstalled, additional time and resources are then required to ensure proper alignment of the engine and its associated components.

### BRIEF DESCRIPTION OF THE INVENTION

According to one embodiment of the invention, an adjustment tool is provided including a block having a plurality of sides including a first side and a second side. A hole is formed in the block such that a first distance between the center of the hole and the first side is different from a second distance between the center of the hole and the second side. The first distance corresponds to a first standard size component and the second distance corresponds to a second standard size component.

In addition to one or more of the features described above, or as an alternative, in further embodiments the distance between the center of the hole and each of the plurality of sides is distinct.

In addition to one or more of the features described above, or as an alternative, in further embodiments the standard size component is a bushing assembly including a bushing and a spacer.

In addition to one or more of the features described above, or as an alternative, in further embodiments the adjustment tool is configured to determine a distance between an opening in a first end of a first connection member and an adjacent surface of a second connection member coupled to the first connection member when the first connection member and the second connection member are in an extended orientation.

In addition to one or more of the features described above, or as an alternative, in further embodiments the hole is substantially identical to the opening formed in the first end of the first connection member.

According to another embodiment of the invention, a connection assembly for mounting a cowl door to an airframe, the cowl door being movable between a closed position and an open position is provided including a first fitting extending from the cowl door. A first connection member has a first end and a second elongated end arranged at an angle to the first end. The first end is coupled to the first fitting and the second end includes a bushing assembly. A first end of the second connection member is operably coupled to a portion of the first connection member. A second end of the second connection member is connected to the airframe. A size of the bushing assembly is adjustable such that when the cowl door is in the open position, the bushing assembly is configured to contact an adjacent surface of the second connection member to limit movement of the cowl door.

In addition to one or more of the features described above, or as an alternative, in further embodiments including a second fitting extending from the cowl door. A first plate is pivotally coupled to the second fitting. The first plate has a first surface configured to mate with a complementary portion of the airframe. The first surface includes a plurality of first teeth.

In addition to one or more of the features described above, or as an alternative, in further embodiments the complementary portion of the airframe includes a plurality of second teeth. The second teeth are substantially identical to and interposed with the first teeth.

In addition to one or more of the features described above, or as an alternative, in further embodiments the complementary portion of the airframe includes a second plate.

In addition to one or more of the features described above, or as an alternative, in further embodiments the first plate is mounted to the complementary portion of the airframe with at least one fastener.

In addition to one or more of the features described above, or as an alternative, in further embodiments an adjustment tool is configured to adjust the bushing assembly. The adjustment tool includes a block having a plurality of sides including a first side and a second side, and a hole formed in the block. A first distance between a center of the hole and the first side is different from a second distance between the center of the hole and the second side. The first distance corresponds to a first standard size bushing assembly. The second distance corresponds to a second standard size bushing assembly.

According to another embodiment of the invention, a method of adjusting a connection assembly coupling a cowl door to an airframe is provided. The connection assembly includes a first fitting extending from the cowl door, a first connection member coupled to the first fitting and the second end including a bushing assembly, and a second connection member operably coupled to a portion of the first connection member and the airframe. The method includes aligning a hole of an adjustment tool with an opening formed in a free end of the first connection member. The adjustment tool is rotated until one of the plurality of sides thereof is in contact with a surface of the second connection member to identify a measured distance. A bushing assembly having a radius substantially equal to the distance is installed into the opening of the first connection member.

In addition to one or more of the features described above, or as an alternative, in further embodiments the adjustment tool includes a block having a plurality of sides including a first side and a second side, and a hole formed in the block. A first distance between a center of the hole and the first side is different from a second distance between the center of the hole and the second side. The first distance corresponds to a first standard size bushing assembly. The second distance corresponds to a second standard size bushing assembly.

In addition to one or more of the features described above, or as an alternative, in further embodiments the hole in the adjustment tool is substantially identical to the opening formed in the free end of the first connection member.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary rotary wing aircraft;

FIG. 2 is a schematic diagram of an example of a gas turbine engine used in a rotary wing aircraft;

FIG. 3 is a side view of an example of a gas turbine engine used in a rotary wing aircraft;

FIG. 4 is a perspective view of an open cowl door of an engine according to an embodiment of the invention;

FIG. 5 is a perspective view of the connection assemblies coupling the cowl door to the airframe of an aircraft according to an embodiment of the invention;

FIG. 6 is a detailed perspective view of a portion of the connection assembly of FIG. 5 according to an embodiment of the invention;

FIG. 7 is a detailed perspective view of a portion of the connection assembly of FIG. 5 according to an embodiment of the invention;

FIG. 8 is a detailed perspective view of a portion of the connection assembly including an adjustment tool according to an embodiment of the invention; and

FIG. 9 is a method of adjusting a portion of the connection assembly according to an embodiment of the invention.

The detailed description explains embodiments of the invention, together with advantages and features, by way of example with reference to the drawings.

### DETAILED DESCRIPTION OF THE INVENTION

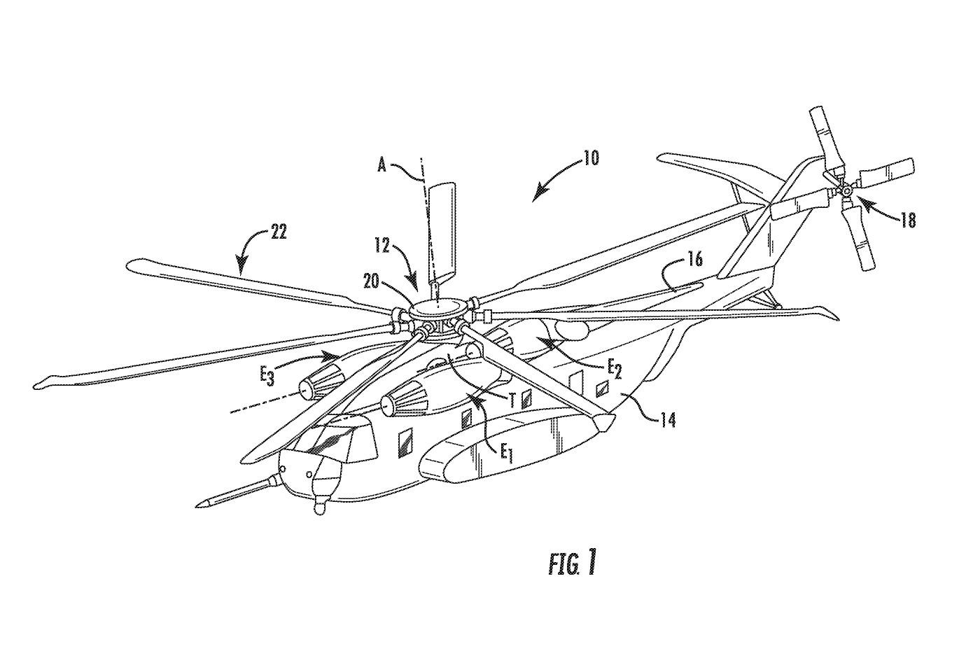

FIG. 1 schematically illustrates a rotary wing aircraft 10 having a main rotor assembly 12. The aircraft 10 includes an airframe 14 having an extending tail 16 which mounts a tail rotor system 18, such as an anti-torque system, a translational thrust system, a pusher propeller, a rotor propulsion system, and the like. The main rotor assembly 12 includes a plurality of rotor blade assemblies 22 mounted to a rotor hub 20. The main rotor assembly 12 is driven about an axis of rotation A through a main gearbox (illustrated schematically at T) by one or more engines E. Although a particular helicopter configuration is illustrated and described in the disclosed embodiment, other configurations and/or machines, such as high speed compound rotary wing aircrafts with supplemental translational thrust systems, dual contra-rotating, coaxial rotor system aircrafts, tilt-rotors and tilt-wing aircrafts, and fixed wing aircrafts, will also benefit from embodiments of the invention.

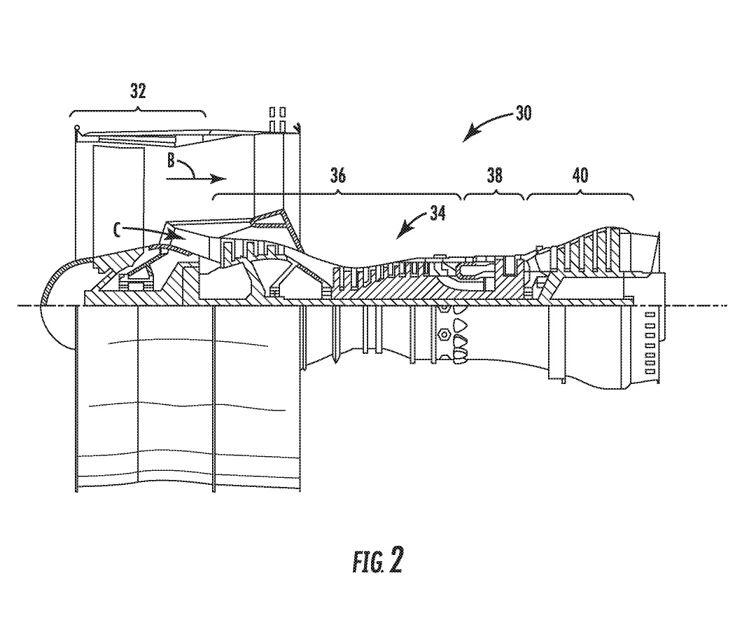

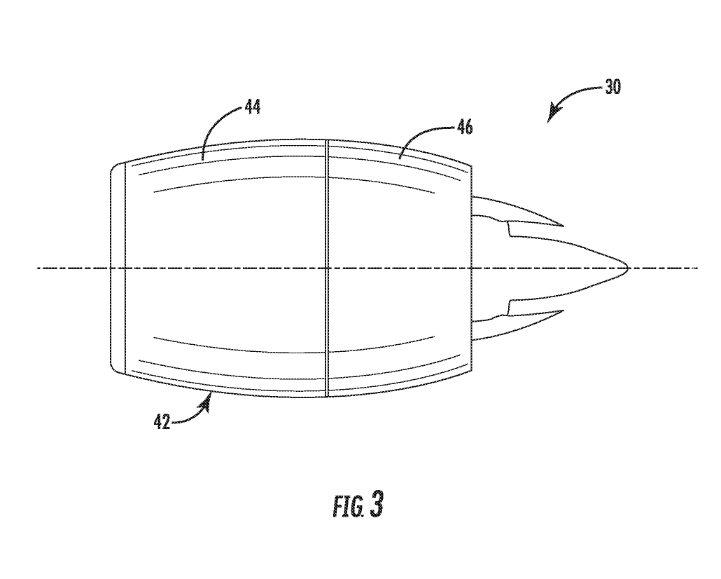

In one embodiment, the engines E of the rotary wing aircraft 10 are gas turbine engines. An example of a gas turbine engine 30 is illustrated in more detail in FIGS. 2 and 3. The gas turbine engine 30 typically includes a fan section 32, and a core engine section 34 including a compressor section 36, a combustor section 38, and a turbine section 40. The fan section 32 drives air along a bypass flow path B while the compressor section 36 draws air in along a core flow path C where air is compressed and communicated to a combustor section 38. In the combustor section 38, air is mixed with fuel and ignited to generate a high-speed exhaust gas stream that expands through the turbine section 40 where energy is extracted and utilized to drive the fan section 32 and the compressor section 36.

The illustrated gas turbine engine 30 is enclosed within a nacelle structure 42. In this example, the nacelle structure 42 includes a fan cowling 44 and an aft cowling assembly 46. The fan cowl 44 and the aft cowl 46 are movable from the closed position (shown) to an open position to allow access to the core engine section 34 and the fan section 32. Although the illustrated, non-limiting embodiment depicts a turbofan gas turbine engine, other types of turbine engines are within the scope of the invention.

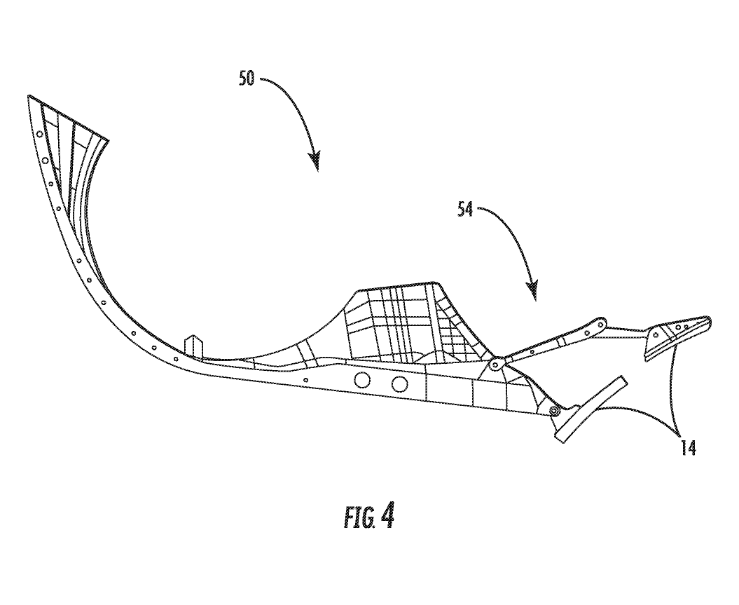

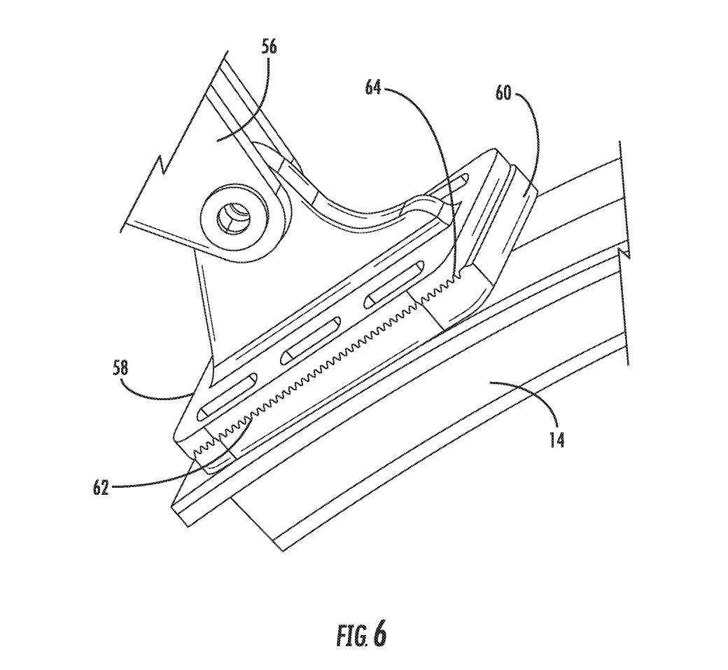

Referring now to FIGS. 4-6, an example of an open cowl door 50 of an engine 30, such as the fan cowl for example, is illustrated. The cowl door 50 includes one or more connection assemblies 54 configured to rotatably mount the cowl door 50 to a portion of the airframe 14 adjacent the engine 30. In the illustrated, non-limiting embodiment, the engine cowl door 50 includes a substantially identical first connection assembly 54a and second connection assembly 54b arranged adjacent a first end 52 thereof.

Each connection assembly 54 includes a first fitting 56 extending generally outwardly from the first end 52 of the cowl door 50 towards the adjacent airframe 14. Pivotally mounted to the first fitting 56 is a plate 58 configured to couple to a complementary portion of the airframe 14 with one or more fasteners (not shown). As illustrated, the airframe 14 may include an integrally formed raised second plate 60, substantially similar size and shape to the first plate 58, and configured to connect thereto. However, in other embodiments, the airframe 14 need not include this raised second plate 60. In the illustrated, non-limiting embodiment, the adjacent surfaces of the first and second plate 58, 60 configured to contact one another include a plurality of first teeth 62 and a plurality of second teeth 64, respectively. The first teeth 62 and second teeth 64 are generally complementary such that when the first plate 58 and the second plate 60 are aligned, the first teeth 62 and the second teeth 64 are interposed.

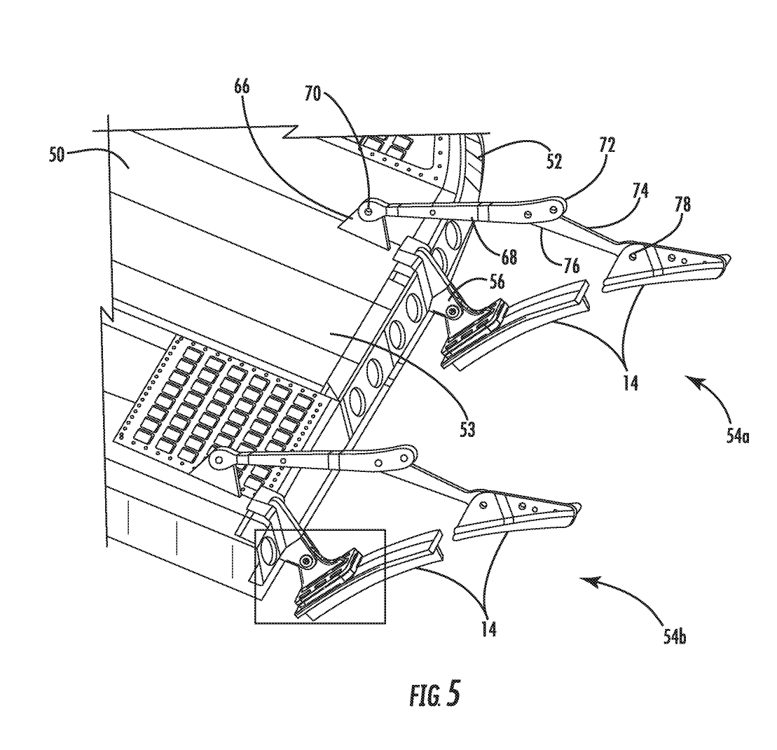

Each connection assembly 54 additionally includes a second fitting 66 substantially aligned with the first fitting 56. In the illustrated embodiment, the second fitting 66 extends generally upwardly from a surface 53 of the cowl door 50, near the first end 52. The connection assembly 54 also includes a first connection member 68 having a first end 70 and an elongate second end 72 extending at an angle to the first end 70. The first end 70 of the first connection member 68 is pivotally coupled to the fitting 66, such as with a pin (not shown) for example. A first end 76 of a second connection member 74 is coupled to a portion of the first connection member 70 and a second end 78 of the second connection member 74 is pivotally mounted to the airframe 14. When the cowl door 50 is closed, the first connection member 68 and the second connection member 74 are arranged in a substantially overlapped configuration (not shown). When the cowl door 50 is opened, as shown in FIGS. 4 and 5, the first connection member 68 and the second connection member 74 are configured in an extended orientation.

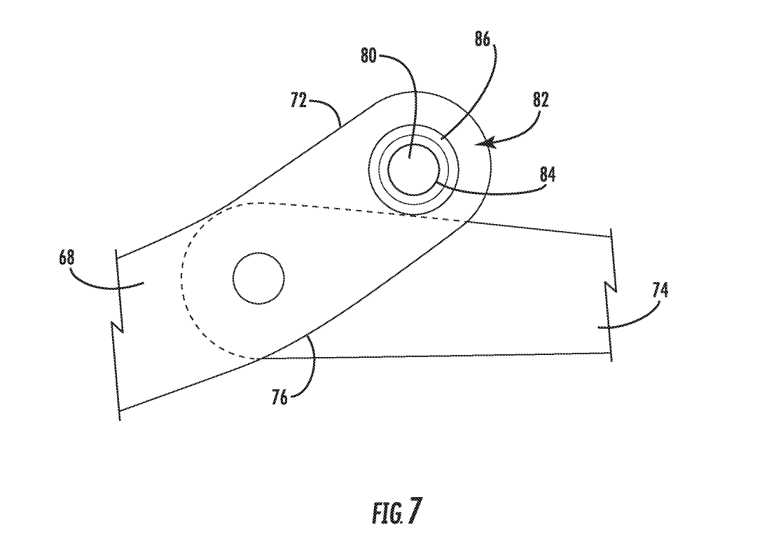

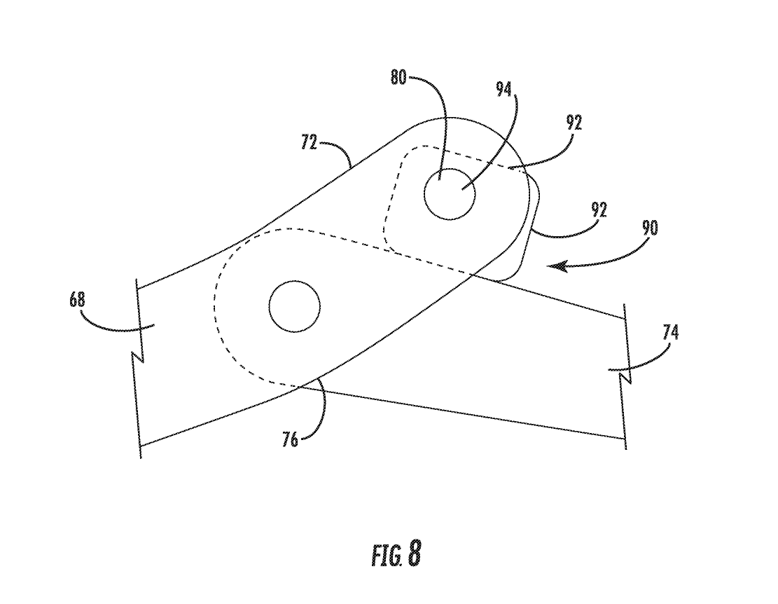

Referring now to FIGS. 7 and 8, the elongate second end 72 of the first connection member 68 is illustrated in more detail. An opening 80 formed in the second end 72 is configured to receive a bushing assembly 82 including a coupled bushing 84 and spacer 86. When the cowl door 50 is in the proper open position, an edge of the bushing assembly 82 contacts an adjacent surface of the second connection member 74 to limit further movement of thereof.

To ensure that the bushing assembly 82 contacts the second connection member 74 when the cowl door 50 is open, an adjustment tool 90 may be used to determine the correct size of the bushing assembly 82 to be installed in opening 80. The adjustment tool 90 is a block having a plurality of sides 92. Although a tool 90 having four sides is illustrated and described herein, an adjustment tool 90 having any number of sides is within the scope of the invention. A hole 94 substantially identical to the opening 80 formed in the second end 72 of the first connection member 68 is formed in the adjustment tool 90. As a result of the positioning of the hole 94, the distance between the center of the hole 94 and at least one of the sides 92 of the adjustment tool 90 is different than the distance between the center of the hole 94 and the remainder of the plurality of sides 92. In the illustrated, non-limiting embodiment, the distance between the hole 94 and each of the four sides 92 of the adjustment tool 90 is unique. The adjustment tool 90 may be configured such that the distance measured between the center of hole 94 and each side 92 of the tool 90 correlates to a standard size radius or other dimension of a bushing assembly 82.

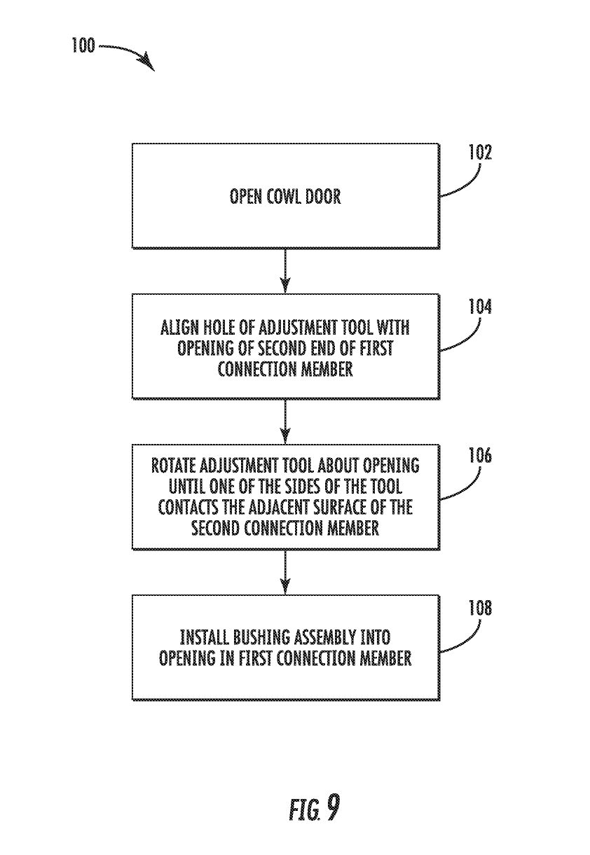

A method 100 of adjusting the alignment of the first and second connection members 68, 74 of the connection assembly 54 is illustrated in FIG. 9. The method 100 includes moving a cowl door 50 of the engine 30 to an open position in block 102. In block 104, the hole of the adjustment tool is aligned with the opening formed in the end of the first connection member. The adjustment tool is then rotated, in block 106, until one of the sides of the tool is in contact with the contact surface of the second connection member. The distance between the opening and the side of the tool in contact with the second connection member indicates the size of the necessary bushing assembly. In block 108, after locating the correct bushing assembly, the bushing assembly is inserted, such as via a press fit operation for example, into the opening in the first connection member.

Use of the adjustment tool allows a mechanic to easily determine the correct size bushing assembly for the first connection member. In turn, installation of an appropriate bushing assembly ensures contact between the first and second connection members when the cowl door is open, thereby eliminating misalignment issues. Inclusion of the serrated plate 58 provides additional adjustability to the interface with the airframe 14 as well.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An adjustment tool comprising:
a block having a plurality of sides including a first side and a second side, a hole is formed in the block such that a first distance between a center of the hole and the first side is different from a second distance between the center of the hole and the second side, wherein the first distance corresponds to a first standard size component and the second distance corresponds to a second standard size component.

2. The adjustment tool according to claim 1, wherein the distance between the center of the hole and each of the plurality of sides is distinct.

3. The adjustment tool according to claim 1, wherein the standard size component is a bushing assembly including a bushing and a spacer.

4. The adjustment tool according to claim 1, wherein the adjustment tool is configured to determine a distance between an opening in a first end of a first connection member and an adjacent surface of a second connection member coupled to the first connection member when the first connection member and the second connection member are in an extended orientation.

5. The adjustment tool according to claim 4, wherein the hole is substantially identical to the opening formed in the first end of the first connection member.

6. A connection assembly for mounting a cowl door to an airframe, the cowl door being movable between a closed position and an open position, comprising:
a first fitting extending from the cowl door;
a first connection member having a first end and an elongated second end arranged at an angle to the first end, the first end being coupled to the first fitting, and the second end including a bushing assembly;
a second connection member having a first end and a second end, the first end being operably coupled to a portion of the first connection member and the second end being connected to the airframe, wherein a size of the bushing assembly is adjustable such that when the cowl door is in the open position, the bushing assembly is configured to contact an adjacent surface of the second connection member to limit movement of the cowl door.

7. The connection assembly of claim 6, further comprising:
a second fitting extending from the cowl door;
a first plate pivotally coupled to the second fitting, the first plate having a first surface configured to mate with a complementary portion of the airframe, the first surface including a plurality of first teeth.

8. The connection assembly of claim 7, wherein the complementary portion of the airframe includes a plurality of second teeth, the second teeth being substantially identical to and interposed with the first teeth.

9. The connection assembly according to claim 6, wherein the complementary portion of the airframe includes a second plate.

10. The connection assembly according to claim 6, wherein the first plate is mounted to the complementary portion of the airframe with at least one fastener.

11. The connection assembly according to claim 6, wherein an adjustment tool is configured to adjust the bushing assembly, the adjustment tool including a block having a plurality of sides including a first side and a second side, and a hole formed in the block such that a first distance between a center of the hole and the first side is different from a second distance between the center of the hole and the second side, wherein the first distance corresponds to a first standard size bushing assembly and the second distance corresponds to a second standard size bushing assembly.

12. A method of adjusting a connection assembly coupling a cowl door to an airframe, the connection assembly including a first fitting extending from the cowl door, a first connection member coupled to the first fitting and the second end including a bushing assembly, and a second connection member operably coupled to a portion of the first connection member and the airframe, the method comprising:
aligning a hole of an adjustment tool with an opening formed in a free end of the first connection member;
rotating the adjustment tool until one of a plurality of sides of the adjustment tool is in contact with a surface of the second connection member to identify a measured distance; and
installing a bushing assembly into the opening in the free end of the first connection member, the bushing assembly having a radius substantially identical to the measured distance.

13. The method of claim 12, wherein the adjustment tool includes a block having a plurality of sides including a first side and a second side, and a hole formed in the block such that a first distance between a center of the hole and the first side is different from a second distance between the center of the hole and the second side, wherein the first distance corresponds to a first standard size bushing assembly and the second distance corresponds to a second standard size bushing assembly.

14. The method of claim 13, wherein the hole in the adjustment tool is substantially identical to the opening formed in the free end of the first connection member.
